(19) United States
(12) Patent Application Publication
(10) Pub. No.: US 2026/0109838 A1
(43) Pub. Date: Apr. 23, 2026

(54) CO-STABILIZERS FOR HYDROXYPHENYL TRIAZINE STABILIZED POLYMERS

(71) Applicant: BASF SE, Ludwigshafen am Rhein (DE)

(72) Inventors: Michèle GERSTER, Basel (CH); Tania WEYLAND, Kaisten (CH); Raphael DABBOUS, Kaisten (CH); Daniel MUELLER, Kaisten (CH); Heinz HERBST, Kaisten (CH); Wiebke WUNDERLICH-WIPPERT, Kaisten (CH)

(21) Appl. No.: 19/117,299

(22) PCT Filed: Sep. 21, 2023
(86) PCT No.: PCT/EP2023/076026

§ 371 Date: Mar. 31, 2025

(30) Foreign Application Priority Data
Sep. 29, 2022 (EP) 22198724.1

(51) Int. Cl. C08K 5/3492

(52) U.S. Cl. CPC C08K 5/3492

(57) ABSTRACT

The present invention relates to a use of a co-stabilizer of the formula (1) as defined below to further increase the stability against degradation induced by light of a synthetic polymer which is stabilized with a hydroxyphenyl triazine, and where the hydroxyphenyl triazine is different from the co-stabilizer of the formula (1).

The present invention relates to a use of a co-stabilizer of the formula (1) as defined below to further increase the stability against degradation induced by light of a synthetic polymer which is stabilized with a hydroxyphenyl triazine, and where the hydroxyphenyl triazine is different from the co-stabilizer of the formula (1).

Various hydroxyphenyl triazine light stabilizers for polymers are known and several are commercially available. There is an ongoing need to further improve the stabilization of polymers which are already stabilized with hydroxyphenyl triazine light stabilizers.

The object was solved by a use of a co-stabilizer of the formula (1)

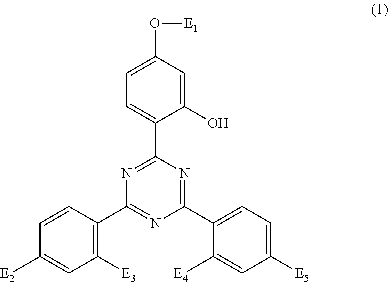

wherein
E₁ is hydrogen, C₁-C₁₈alkyl, C₁-C₁₈alkyl substituted by 1, 2 or 3 radicals selected from the group consisting of —OH, C₂-C₁₈alkenyloxy, —C(O)OX₁ and —OC(O)X₂ with X₁ and X₂ being independently C₁-C₁₈alkyl; C₃-C₅₀alkyl interrupted by oxygen or C₃-C₅₀hydroxyalkyl interrupted by oxygen; and
E₂, E₃, E₄ and E₅ are independently hydrogen, C₁-C₁₈alkyl, phenyl or phenyl substituted by 1, 2 or 3 C₁-C₄alkyl;
to further increase the stability against degradation induced by light of a synthetic polymer which is stabilized with a hydroxyphenyl triazine, and where the hydroxyphenyl triazine is different from the co-stabilizer of the formula (1).

The co-stabilizer is used to further Increase the stability against degradation induced by light of the synthetic polymer which is stabilized with the hydroxyphenyl triazine. The further increase of stability against degradation induced by light can be determined when comparing a) the synthetic polymer stabilized with the hydroxyphenyl triazine, but without the co-stabilizer, and b) the synthetic polymer stabilized with the hydroxyphenyl triazine and the co-stabilizer.

The stability against degradation induced by light of the synthetic polymer usually means the stability against exposure to UV light. The stability of the synthetic polymer can be determined by various methods, such as
Color coordinate L*, in CIELAB units, according to ISO 4582, where a zero defines black and 100 defines white.
Color difference deltaE*, in CIELAB units, is taken as the square root of the squares of the differences in the L*, a* and b* CIELAB color coordinates at time of recall minus time zero, as defined in ISO 11664-4.
Clarity and haze in % according to ASTM D1003.
Haze [%] over exposure according to ASTM G 155 cycle 4.
Clarity [%] over exposure according to ASTM G 155 cycle 4,
Yellowness Index, without unit, according to ASTM E313.
Yellowness Index over exposure according to ASTM G 155 cycle 4.
Maximum force [%] over exposure according to DIN EN ISO 105 B04.
Absorbance [%] at 290 nm over exposure according to DIN EN ISO 4892-2 cycle 5.

The weight ratio of the co-stabilizer to the hydroxyphenyl triazine is usually from 2:1 to 1:150, preferably from 1:5 to 1:80, and in particular from 1:25 to 1:50.

The co-stabilizer has the formula (1)

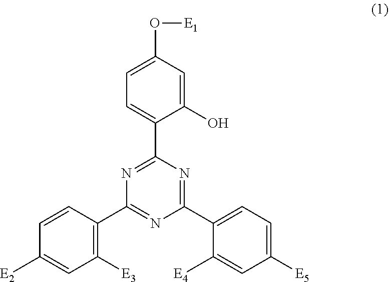

wherein
E₁ is hydrogen, C₁-C₁₈alkyl, C₁-C₁₈alkyl substituted by 1, 2 or 3 radicals selected from the group consisting of —OH, C₂-C₁₈alkenyloxy, —C(O)OX₁ and —OC(O)X₂ with X₁ and X₂ being independently C₁-C₁₈alkyl; C₃-C₅₀alkyl interrupted by oxygen or C₃-C₅₀hydroxyalkyl interrupted by oxygen; and
E₂, E₃, E₄ and E₅ are independently hydrogen, C₁-C₁₈alkyl, phenyl or phenyl substituted by 1, 2 or 3 C₁-C₄alkyl.

Examples of C₁-C₁₈alkyl are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethyl-hexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl and octadecyl. C₁-C₈alkyl, for example methyl, n-butyl, 2-ethylhexyl or an isomeric mixture of octyl, is particularly preferred.

Preferably, E₁ is C₁-C₁₃alkyl, in particular linear or branched octyl.

Preferred examples of C₁-C₁₈alkyl, preferably C₃-C₁₈alkyl, substituted by 1, 2 or 3 radicals selected from the group consisting of —OH, C₂-C₁₈alkenyloxy, —C(O)OX₁ (or —C(O)OY₁) and —OC(O)X₂ (or —OC(O)Y₂) are 2-hydroxyethyl,

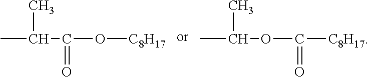

An example of C₃-C₅₀alkyl interrupted by one or more oxygen is —(CH₂CH₂—O—)₃—CH₃.

Preferred examples of C₃-C₅₀hydroxyalkyl interrupted by oxygen are

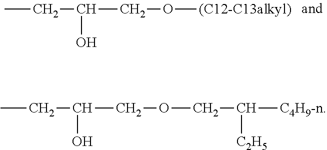

A preferred example of phenyl substituted by 1, 2 or 3 C₁-C₄alkyl is 2,4-dimethylphenyl.

Preferably, the co-stabilizer is selected from the formulae (2), (3), and (4)

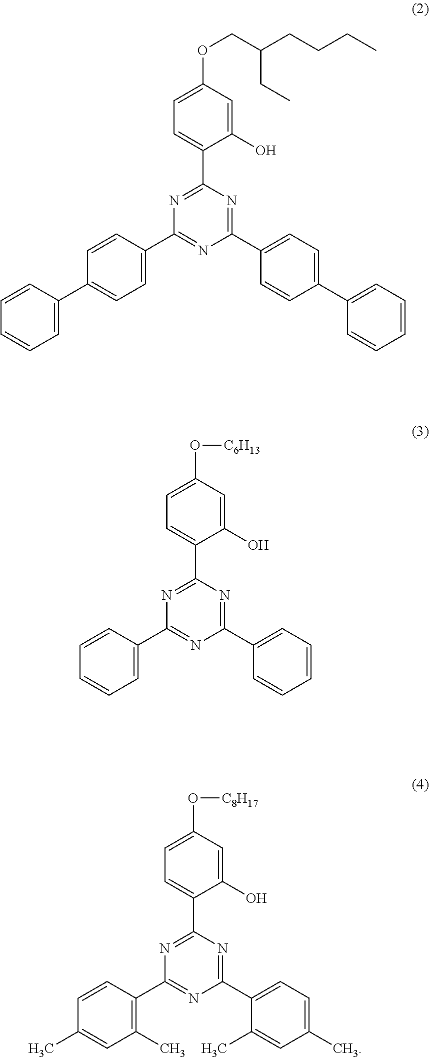

The co-stabilizer may be present in the synthetic polymer in an amount of 0.0005 to 10%, preferably 0.005 to 5%, and in particular 0.01 to 2.5% or 0.05 to 2%, relative to the weight of the synthetic polymer.

In another form the co-stabilizer may be present in the synthetic polymer in an amount of up to 10, 5, 1, 0.1, 0.05, 0.01, 0.005, 0.001, or 0.0001% relative to the weight of the synthetic polymer.

The synthetic polymer is stabilized with a hydroxyphenyl triazine, where the hydroxyphenyl triazine is different from the co-stabilizer of the formula (1).

The hydroxyphenyl triazine is different from the co-stabilizer of the formula (1) usually means that the hydroxyphenyl triazine and the co-stabilizer of the formula (1) do not have the same chemical structure.

The hydroxyphenyl triazine may be present in the synthetic polymer in an amount of 0.005 to 10 %, preferably 0.005 to 5%, and in particular 0.01 to 2.5% or 0.05 to 2%, relative to the weight of the synthetic polymer.

The hydroxyphenyl triazine is at least one compound selected from the formulae (B-1) and (B-11)

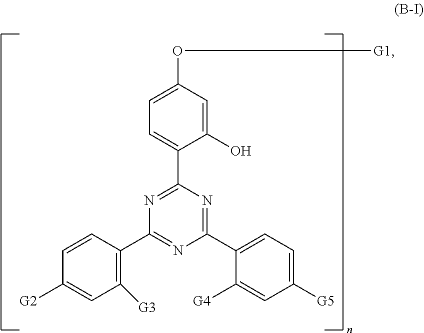

wherein G₂, G₃, G₄ and G₅ independently of one another are hydrogen, C₁-C₁₈alkyl, phenyl or phenyl substituted by 1, 2 or 3 C₁-C₄alkyl;
n is 1 or 2,
when n is 1, G₁ is C₁-C₁₈alkyl, or C₂-C₁₈hydroxyalkyl which is interrupted by oxygen, and
when n is 2, G₁ is a bridging group of formula ROCOR′, wherein R and R′ independently of one another are C₁-C₁₈alkylidene,

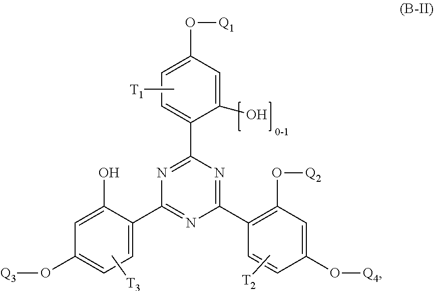

wherein Q₁, Q₂, Q₃ and Q₄ are independently of one another hydrogen, C₁-C₁₈alkyl, C₁-C₁₈alkyl substituted by hydroxy, C₂-C₁₈alkyl or C₂-C₁₈hydroxyalkyl interrupted by oxygen, C₁-C₁₈alkyl substituted by 1, 2 or 3 radicals selected from the group consisting of —OH, C₂-C₁₈alkenyloxy, —C(O)OX₁ and —OC(O)X₂ with X₁ and X₂ being independently C₁-C₁₈alkyl, and T₁, T₂ and T₃ are independently from each other hydrogen or C₁-C₁₈alkyl.

Preferably, in the hydroxyphenyl triazine of the formulae (B-1) and (B-11)
G₂, G₃, G₄ and G₅ are independently from each other hydrogen, C₁-C₄alkyl or phenyl, Q₁, Q₂, Q₃ and Q₄ are independently from each other hydrogen or C₁-C₁₀alkyl, and T₁, T₂ and T₃ are independently from each other hydrogen or C₁-C₄alkyl.

Examples of C₁-C₁₈alkyl are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl and octadecyl.

An example for C₂-C₁₈hydroxyalkyl which is interrupted by oxygen is the group of formula —CH₂—CH(OH)—CH₂—O—CH₂—CH(C₂H₅)—(CH₂)₃—CH₃.

An example of phenyl substituted by 1, 2 or 3 C₁-C₄alkyl is 2,4-dimethylphenyl.

Examples of C₁-C₁₂alkyloxy are methoxy, ethoxy, propoxy, isopropoxy, butoxy, isobutoxy, pentoxy, isopentoxy, hexoxy, heptoxy, octoxy and decyloxy. C₁-C₈alkyloxy, in particular propoxy, is preferred.

Preferred examples of C₁-C₁₈,alkyl, preferably C₃-C₁₈alkyl, substituted by 1, 2 or 3 radicals selected from the group consisting of —OH, C₂-C₁₈alkenyloxy, —C(O)OX₁ (or —C(O)OY₁) and —OC(O)X₂ (or —OC(O)Y₂) are 2-hydroxyethyl, —CH₂CH₂OC(O)C₇H₁₅,

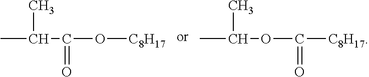

Examples of C₁-C₁₈alkylidene are methylidene, ethylidene, propy-lidene, butylidene, pentylidene, hexylidene, heptylidene, octylidene, nonylidene, decyli-dene, undecylidene, dodecylidene, tridecylidene, tetradecylidene, pentadecylidene, hexa-decylidene, heptadecylidene, and octadecylidene.

The bridging group of formula ROCOR′ is preferably

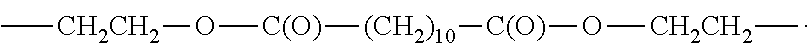

Preferably, the hydroxyphenyl triazine is at least one compound selected from the formulae (B1) to (B6)

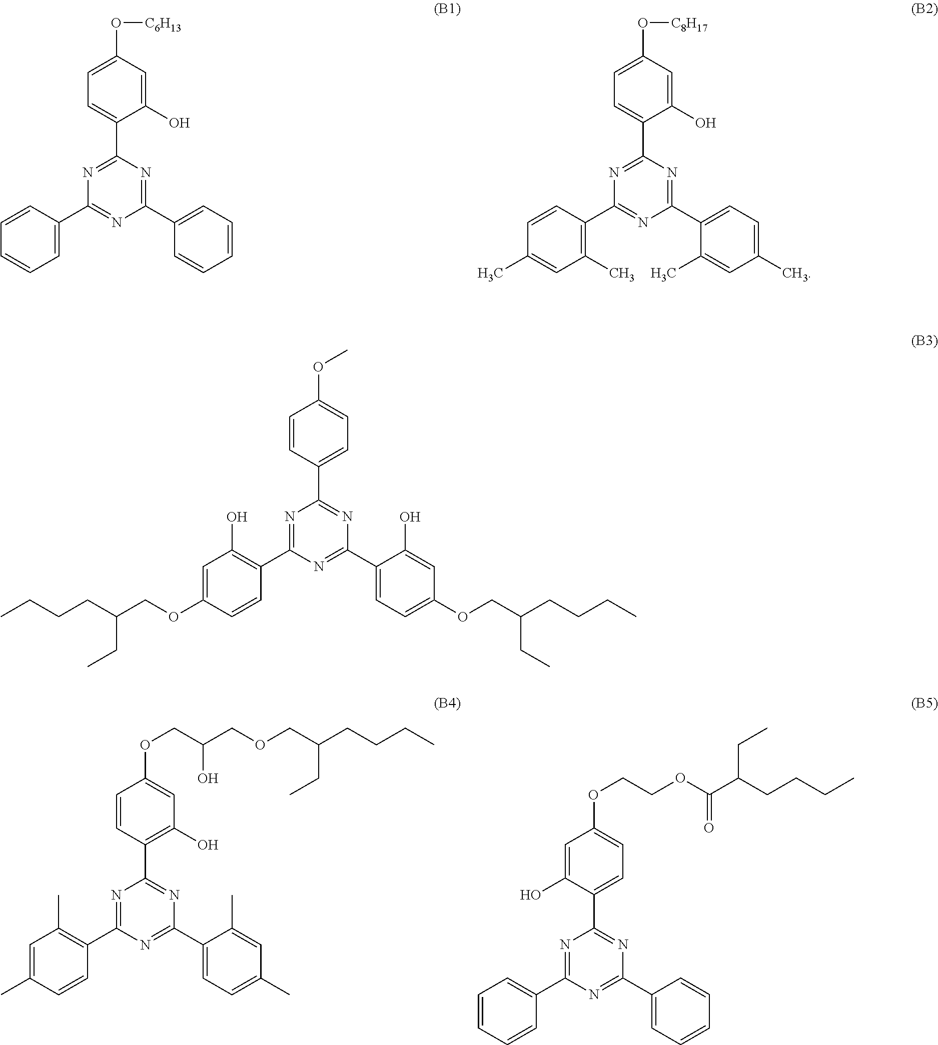

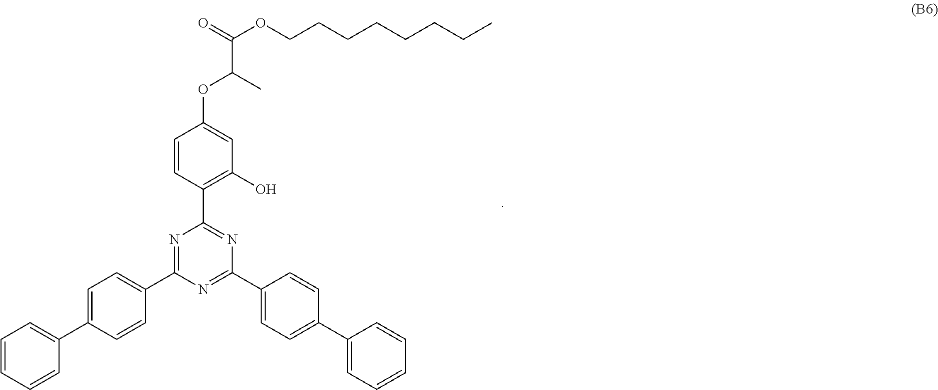 [SMILES: CCCCCCCCOC(=O)C(C)Oc1ccc(-c2nc(-c3ccc(-c4ccccc4)cc3)nc(-c3ccc(-c4ccccc4)cc3)n2)c(O)c1]

### EXAMPLES OF SYNTHETIC POLYMERS ARE

1. Polymers of monoolefins and diolefins, for example polypropylene, polyisobutylene, polybut-1-ene, poly-4-methylpent-1-ene, polyvinylcyclohexane, polyisoprene or poly-butadiene, polyhexene, polyoctene, as well as polymers of cycloolefins, for instance of cyclopentene, cyclohexene, cyclooctene or nor-bomene, polyethylene (which optionally can be crosslinked), for example high density polyethylene (HDPE), high density and high molecular weight polyethylene (HDPE-HMV), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, Vib or ViII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups.

These catalyst systems are usually termed Phillips, Standard Oil Indiana, Ziegler (-Natta), TNZ (DuPont), metallocene or single-site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), very low density polyethylene, propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbomene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbomene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred.

Stereoblock polymers are also included. Copolymers from 1.)-4.) may by random or block-copolymers, homo- or heterophasic, or High Crystalline Homopolymer.

5. Polystyrene, poly(p-methylstyrene), poly(a-methylstyrene).

6. Aromatic homopolymers and copolymers derived from vinyl aromatic monomers including styrene, a-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred.

Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/isoprene/butadiene/styrene, styrene/ethylene/butylene/styrene or styrene/ethylene/propylene/styrene, HIPS, ABS, ASA, AES.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or a-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorin-ated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride (PVC), polyvinylidene chloride, polyvinyl fluoride, polyvinylidene fluoride, as well as copolymers thereof such as vinyl chlorid/vinylidene chloride, vinyl chloride/vinyl acetate or vinylidene chloride/vinyl acetate copolymers. Polyvinyl chloride may be rigid or flexible (plasticized).

9. Polymers derived from α,β-unsaturated acids and derivatives thereof such as polyacrylates and polymethacrylates; poly(methyl methacrylates), polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or poly-butadienes on the one hand and aliphatic or aromatic polyisocyanates on the other, as well as precursors thereof. Polyurethanes formed by the reaction of: (1) diisocyanates with short-chain diols (chain extenders) and (2) diisocyanates with long-chain diols (thermoplastic polyurethanes, TPU).

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems). The poylamides may be amorphous.

17. Polyureas, polyimides, polyamideimides, polyetherimides, polyesterimides, polyhydantoins and polybenzimidazoles.

18. Polyesters derived from dicarboxylic acids and diols and/or from hydroxycarboxylic acids or the corresponding lactones or lactides, for example polyethylene terephthalate (PET), polybutylene terephthalate, poly-1,4-dimethylolcyclohexane terephthalate, polypropylene terephthalate, polyalkylene naphthalate and polyhydroxybenzoates as well as copolyether esters derived from hydroxyl-terminated polyethers, and also polyesters modified with polycarbonates or MBS. Copolyesters may comprise, for example—but are not limited to -polybutyl-enesuccinate/terephtalate, polybutyleneadipate/terephthalate, polytetramethylenead-ipate/terephthalate, polybutylensuccinate/adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to the class of poly(hydroxyalkanoates), in particular, poly(propiolactone), poly(butyrolactone), poly(pivalolactone), poly(valerolactone) and poly(caprolactone), polyethylenesuccinate, polypropylenesuccinate, polybutylenesuccinate, polyhexamethylenesuccinate, polyethyleneadipate, polypropyleneadipate, polybutyleneadipate, polyhexamethyleneadipate, polyethyleneoxalate, polypropyleneoxalate, polybutyleneoxalate, polyhexamethyleneoxalate, polyethylenesebacate, polypropylenesebacate, polybutylenesebacate, polyethylene furanoate and polylactic acid (PLA) as well as corresponding polyesters modified with polycarbonates or MBS. The term “polylactic acid (PLA)” designates a homo-polymer of preferably poly-L-lactide and any of its blends or alloys with other polymers; a co-polymer of lactic acid or lactide with other monomers, such as hydroxy-carboxylic acids, like for example glycolic acid, 3-hydroxy-butyric acid, 4-hydroxy-butyric acid, 4-hydroxy-valeric acid, 5-hydroxy-valeric acid, 6-hydroxy-caproic acid and cyclic forms thereof; the terms “lactic acid” or “lactide” include L-lactic acid, D-lactic acid, mixtures and dimers thereof, i.e. L-lactide, D-lactide, meso-lactide and any mixtures thereof. Preferred polyesters are PET, PET-G, PBT.

19. Polycarbonates and polyester carbonates. The polycarbonates are preferably prepared by reaction of bisphenol compounds with carbonic acid compounds, in particular phosgene or, in the melt transesterification process, diphenyl carbonate or dimethyl carbonate. Homopolycarbonates based on bisphenol A and copolycarbonates based on the monomers bisphenol A and 1,1-bis-(4-hydroxyphenyl)-3,3,5-trimethylcyclohexane (bisphenol TMC) are particularly preferred. These and further bisphenol and diol compounds which can be used for the polycarbonate synthesis are disclosed inter alia in WO08037364 (p. 7, line 21 to p.10, line 5), EP1582549 ([0018] to [0034]), WO02026862 (p.2, line 23 to p.-5, line 15), WO05113639 (p. 2, line 1 to p.7, line 20). The polycarbonates can be linear or branched. Mixtures of branched and unbranched polycarbonates can also be used. Suitable branching agents for polycarbonates are known from the literature and are described, for example, in patent specifications U.S. Pat. No. 4,185,009 and DE2500092 (3,3-bis-(4-hydroxyaryl-oxindoles according to the invention, see whole document in each case), DE4240313 (see p.3, line 33 to 55), DE19943642 (see p.5, line 25 to 34) and U.S. Pat. No. 5,367,044 as well as in literature cited therein. The polycarbonates used can additionally be intrinsically branched, no branching agent being added here within the context of the polycarbonate preparation. An example of intrinsic branchings are so-called Fries structures, as are disclosed for melt polycarbonates in EP1506249. Chain terminators can additionally be used in the polycarbonate preparation. Phenols such as phenol, alkylphenols such as cresol and 4-tert-butylphenol, chlorophenol, bromophenol, cumyiphenol or mixtures thereof are preferably used as chain terminators. Polyester carbonates are obtained by reaction of the bisphenols already mentioned, at least one aromatic dicarboxylic acid and optionally carbonic acid equivalents. Suitable aromatic dicarboxylic acids are, for example, phthalic acid, terephthalic acid, isophthalic acid, 3,3′- or 4,4′-diphenyldicarboxylic acid and benzophenone-dicarboxylic acids. A portion, up to 80 mol-%, preferably from 20 to 50 mol-%, of the carbonate groups in the polycarbonates can be replaced by aromatic dicarboxylic acid ester groups.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A, bisphenol E and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and co-polymers, PA/HDPE, PA/PP, PA/PPO, PBT/PC/ABS or PBT/PET/PC.

30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

31. Aqueous emulsions of natural or synthetic rubber, e.g. natural latex or latices of carboxylated styrene/butadiene copolymers.

32. Adhesives, for example block copolymers such as SIS, SBS, SEBS, SEPS (S represents styrene, I isoprene, B polybutadiene, EB ethylene/butylene block, EP polyethylene/polypropylene block).

33. Rubbers, for example polymers of conjugated dienes, e.g. polybutadiene or polyisoprene, copolymers of mono- and diolefins with one another or with other vinyl monomers, copolymers of styrene or α-methylstyrene with dienes or with acrylic derivatives, chlorinated rubbers, natural rubber.

34. Elastomers, for example natural polyisoprene (cis-1,4-polyisoprene natural rubber (NR) and trans-1,4-polyisoprene gutta-percha), Synthetic polyisoprene (IR for isoprene rubber), Polybutadiene (BR for butadiene rubber), Chloroprene rubber (CR), polychloroprene, Neoprene, Baypren etc., Butyl rubber (copolymer of isobutylene and isoprene, IIR), Halogenated butyl rubbers (chloro butyl rubber: CIIR; bromo butyl rubber BIIR), Styrene-butadiene Rubber (copolymer of styrene and butadiene, SBR), Nitrile rubber (copolymer of butadiene and acrylonitrile, NBR), also called Buna N rubbers Hydrogenated Nitrile Rubbers (HNBR) Therban and Zetpol, EPM (ethylene propylene rubber, a copolymer of ethylene and propylene) and EPDM rubber (ethylene propylene diene rubber, a terpolymer of ethylene, propylene and a diene-component), Epichlorohydrin rubber (ECO), Polyacrylic rubber (ACM, ABR), Silicone rubber (SI, Q, VMQ), Fluorosilicone Rubber (FVMQ), Fluoroelastomers (FKM, and FEPM) Viton, Tecnoflon, Fluorel, Aflas and Dai-El, Perfluoroelastomers (FFKM) Tecnoflon PFR, Kalrez, Chemraz, Perlast, Polyether block amides (PEBA), Chlorosulfonated polyethylene (CSM), (Hypalon), Ethylene-vinyl acetate (EVA), Thermoplastic elastomers (TPE), The proteins resilin and elastin, Polysulfide rubber, Elastolefin, elastic fiber used in fabric production.

35. Thermoplastic elastomers, for example Styrenic block copolymers (TPE-s), Thermoplastic olefins (TPE-o), Elastomeric alloys (TPE-v or TPV), Thermoplastic polyurethanes (TPU), Thermoplastic copolyester, Thermoplastic polyamides, Reactor TPO's (R-TPO's), Polyolefin Plastomers (POP's), Polyolefin Elastomers (POE's).

Preferred synthetic polymers are polymers of above classes
6 (Aromatic homopolymers and copolymers derived from vinyl aromatic monomers), such as ABS;
9 (Polymers derived from α,β-unsaturated acids and derivatives thereof), such as PMMA;
11 (Polymers derived from unsaturated alcohols and amines or the acyl derivatives or acetals thereof), such as PVB;
18 (Polyesters derived from dicarboxylic acids and diols and/or from hydroxycarboxylic acids or the corresponding lactones or lactides), such as PET; and
19 (Polycarbonates and polyester carbonates), such as polycarbonates.

In another preferred form the synthetic polymers are polyethylene terephthalates, poly(methyl methacrylates), acrylonitrile butadiene styrene copolymers, polyvinylbutyral or polycarbonates.

In another preferred form the synthetic polymers are acrylonitrile butadiene styrene copolymer.

In another preferred form the synthetic polymers are polycarbonates.

In another preferred form the synthetic polymers are polyvinylbutyral.

In another preferred form the synthetic polymers are poly(methyl methacrylates).

In another preferred form the synthetic polymers are polyethylene terephthalates.

Also suitable as synthetic polymer is recycled plastics, which may be obtainable from domestic, commercial and industrial waste or from useful material collections. The recycled plastics may originate from separation and sorting, or from specific industrial sectors and return obligations, for example from the automobile industry, electrical/electronic industry, construction, agriculture and the textile industry, or from households and commerce (for example supermarkets). The recycled plastics can be single-material recycled plastics, for example from the polymer classes consisting of the polyolefins (polypropylene, high-density polyethylene, low-density polyethylene and polypropylene blends, and copolymers, such as PP/EPDM and PP/PE and polystyrene), or defined mixtures of recycled plastics.

The recycled plastics may also contain polyethylene terephthalate, polyamides, polycarbonate, cellulose acetate and polyvinylidene chloride. Secondary amounts, up to about 5%, of non-thermoplastics, for example polyurethanes, formaldehyde resins and phenolic resins, and typical amino resins, and also elastomers, for example vulcanized or unvulcanized rubber, may also be present. In certain plastic wastes, small amounts of foreign substances, for example, paper, pigments and adhesives, which are frequently difficult to remove, may also be present. These foreign substances may also originate from contact with diverse substances during use or processing, for example fuel residues, paint components, traces of metal, initiator residues or traces of water.

The Incorporation of the co-stabilizer and the hydroxyphenyl triazine in the synthetic polymer can be achieved by conventional methods, such as adding the modifier blend or its single components to the polymeric material. The components can be added to the synthetic polymer in the form of a liquid, a powder, granule or a masterbatch. The co-stabilizer and the hydroxyphenyl triazine and optionally further additives may be added to the synthetic polymer either individually or mixed with one another. It is preferred that the co-stabilizer and the hydroxyphenyl triazine are added together, such as in the form of a masterbatch.

The synthetic polymers processed according to this invention can be used in a wide variety of forms, for example as films, fibers (continuous or non-continuous), tapes, or moulded articles. Fibers, including bicomponent fibers, are preferred. Bicomponent fibers are meant to be fibers comprising at least two distinct polymeric domains a) and b) in intimate adherence along the length of the fibers. These can be of any shapes, and are not limited to a particular shape.

Examples of such shapes are side-by-side; sheath-core, orange, and matrix and fibrils types. Preferred are sheath-core type bicomponent fibers and side-by-side type bicomponent fibers, especially sheath-core type bicomponent fibers.

Preferred articles are nonwoven fabrics which shall also include webs and shall mean a textile structure of individual fibers, filaments, or threads that are directionally or randomly oriented and bonded by friction, and/or cohesion and/or adhesion and/or mechanical process, as opposed to a regular pattern of mechanically inter-engaged fibers, i.e., it is not a woven or knitted fabric. Examples of nonwoven fabrics include melt-blown filaments, spun-bond continuous filament webs, carded webs, air-laid webs, and wet-laid webs. Suitable bonding methods include thermal bonding, chemical or solvent bonding, resin bonding, mechanical needling, hydraulic needling, stitch-bonding. Suitable articles made of the polymeric material are geotextiles, roofing, cables, films, filtration media, filter, diapers, sanitary napkins, panty liners, incontinence products for adults, protective clothing, surgical drapes, surgical gown, or surgical wear.

The synthetic polymer may comprise further components as additives. These further additives may for example be selected from the following list:

### 1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethyl-phenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-y)phenol, 2,4-dimethyl-6-(1′-methyl-1′-tetradecyl-methyl)-phenol and mixtures thereof.

1.2. Alkylthiomethylphenols, for example 2,4-dioctylthiomethyl-6-tert-butylphenol, 2,4-dioctytthio-methyl-6-methylphenol, 2,4-dioctytthiomethyl-6-ethylphenol, 2,6-di-dodecyl-thiomethyl-4-nonyl-phenol.

1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octadecyl-oxy-phenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example a-tocopherol, b-tocopherol, g-tocopherol, d-tocopherol and mixtures thereof (vitamin E), vitamin E acetate.

Especially preferred is the addition of 2,5,7,8-tetramethyl-2-[4,8,12-trmethyltrdecyl]-chroman-6-ol], which is a commercially available vitamin E (e.g. Irganox E 201™).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(a-methylcyclohexyl)phenol], 2,2′-methylenebis(4-methyl-6-cyclohexylphenyl), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(a-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane.

1.7. O—, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzylmalonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxy-benzyl)-2,4,6-trimethylbenzene, 1,4-bis(3,5-di-tert-butyl-4-hydroxybenzyl)-2,3,5,6-tetra-methylbenzene, 2,4,6-tris(3,5-di-tert-butyl-4-hydroxybenzyl)phenol.

1.10. Triazine compounds, for example 2,4-bis(octylmercapto)-8-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexa-hydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid, (3,5-ditert-butyl-4-hydroxy-phenyl)methylphosphonic acid.

1.12. Acylaminophenols, for example 4-hydroxylauranilide, 4-hydroxystearamide, octyl N-(3,5-di-tert-butyl-4-hydroxyphenyl)carbamate.

1.13. Esters of p-(3,5-di-tert-butyl-4-hydroxyphenyl)propionic acid with mono- or polyhydric alcohols, for example with methanol, ethanol, n-octanol, i-octanol, a mixture of linear and branched C₇-C₉-alkanol, octadecanol, a mixture of linear and branched C₁₃-C₁₈-alkanol, 1,6-hexanediol, 1,9-nonanediol, ethylene glycol, 1,2-propanediol, neopentyl glycol, thiodiethylene glycol, diethylene glycol, triethylene glycol, tetraethylene glycol, pentaerythritol, tris-(hydroxyethyl)isocyanurate, N,N′-bis-(hydroxy-ethyl)oxamide, 3-thiaundecanol, 3-thiapentan-decanol, trimethylhexanediol, trimethylolpropane, 4-hydroxymethyl-1-phospha-2,6,7-trioxabicyclo[2.2.2]octane. Preferred are esters of p-(3,5-di-tert-butyl-4-hydroxyphenyl)propionic acid, especially with octadecanol, such as the addition of Octadecyl-3-(3,5-di-tert.butyl-4-hydroxypheny)-propionate, which is a commercially available as e.g. Irganox1076™.

1.14. Esters of p-(5-tert-butyl-4-hydroxy-3-methylpheny)propionic acid with mono- or polyhydric alcohols, for example with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy)-1,1-dimethylethyl]-2,4,8,10-tetraoxaspiro[5.5]undecane.

1.15. Esters of p-(3,5-dicyclohexyl-4-hydroxypheny)propionic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)ox-amide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of p-(3,5-di-tert-butyl-4-hydroxyphenyl)propionic acid, for example N,N′-bis(3,5-di-tert-butyl-4-hydroxyphenylpropionyl)hexamethylenediamine, N,N′-bis(3,5-di-tert-butyl-4-hydroxyphenylpropionyltrimethylenediamide, N,N′-bis(3,5-di-tert-butyl-4-hydroxyphenyl-propionyl)hydrazide, N,N′-bis[2-(3-[3,5-di-tert-butyl-4-hydroxyphenyl]propionyloxy)ethyl]oxamide (Naugard XL-1 (RTM), supplied by SI Group).

1.18. Ascorbic acid (vitamin C) 1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclo-hexyl-p-phenylenediamine, N,N′-diphenyl-p-phenylenediamine, N,N′-bis(2-naphthyl)-p-phenyl-enediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, nonylated diphenylamine, octylated diphenylamine, for example p,p′-di-tert-octyldiphenylamine, 4-n-butylaminophenol, 4-butyrylaminophenol, 4-nonanoylaminophenol, 4-do-decanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodipheny-Imethane, N,N,N′,N′-tetramethyl-4,4′-diaminodiphenylmethane, 1,2-bis[(2-methylphenyl)amino]-ethane, 1,2-bis(phenylamino)propane, (o-tolyl)biguanide, bis[4-(1′,3′-dimethylbutyl)-phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines or a mixture of mono- and dialkylated tert-octylphenothiazines, N-allylphenothiazine, N,N,N′,N′-tetraphenyl-1,4-diaminobut-2-ene, N-[(1,1,3,3-tetramethylbutyl)phenyl]-1-napthalenamine](commercially available as Irganox L06™).

Alternatively, or in addition, a commercially available mixture of additives may be used as well, of which especially preferred is Irganox 5057™, which is obtained by the reaction of diphenylamine with diisobutylene, and which comprises
(A)₅₀₅₇ diphenylamine;
(B)₅₀₅₇ 4-tert-butyldiphenylamine;
(C)₅₀₅₇ compounds of the group
   i) 4-tert-octyldiphenylamine,
   ii) 4,4′-di-tert-butyldiphenylamine,
   iii) 2,4,4′-tris-tert-butyldiphenylamine,
(D)₅₀₅₇ compounds of the group
   i) 4-tert-butyl-4′-tert-octyldiphenylamine,
   ii) o,o′, m,m′, or p,p′-di-tert-octyldiphenylamine,
   iii) 2,4-di-tert-butyl-4′-tert-octyldiphenylamine,
(E)₅₀₅₇ compounds of the group
   i) 4,4′-di-tert-octyldiphenylamine,
   ii) 2,4-di-tert-octyl-4′-tert-butyldiphenylamine, and
      wherein not more than 5% by weight of component (A)₅₀₅₇ , 8 to 15% by weight of component (B)₅₀₅₇ , 24 to 32% by weight of component (C)₅₀₅₇ , 23 to 34% by weight of component (D)₅₀₅₇ and 21 to 34% by weight of component (E)₅₀₅₇ are present.

2. UV absorbers and light stabilizers

2.1. 2-(2′-Hydroxyphenyl)benzotiazoles, for example 2-(2′-hydroxy-5′-methylphenyl)benzo-triazole, 2-(3′,5′-di-tert-butyl-2′-hydroxyphenyl)benzotriazole, 2-(5′-tert-butyl-2′-hydroxyphenyl)-benzotiazole, 2-(2′-hydroxy-5′-(1,1,3,3-tetramethylbutyl)phenyl)benzotrazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotiazole, 2-(3′-sec-butyl-5′-tert-butyl-2′-hydroxyphenyl)benzotrazole, 2-(2′-hydroxy-4′-octyloxyphenyl)benzotriazole, 2-(3′,5′-di-tert-amyl-2′-hydroxyphenyl)benzotrazole, 2-(3′,5′-bis(α,α-dimethylbenzyl)-2′-hydroxyphenyl)benzotrazole, 2-(3′-tert-butyl-2′-hydroxy-5′-(2-octyl-oxycarbonylethylphenyl)-5-chlorobenzotrazole, 2-(3′-tert-butyl-5′-[2-(2-ethylhexyloxy)carbonyl-ethyl]-2′-hydroxyphenyl)-5-chlorobenzotriazole, 2-(3′-tert-butyl-2′-hydroxy-5′-(2-methoxycarbon-ylethyl)phenyl)-5-chlorobenzotriazole, 2-(3′-tert-butyl-2′-hydroxy-5′-(2-methoxycarbonylethyl)-phenylbenzotiazole, 2-(3′-tert-butyl-2′-hydroxy-5′-(2-octyloxycarbonylethyl)pheny)benzotri-azole, 2-(3′-tert-butyl-5′-[2-(2-ethylhexyloxy)carbonylethyl]-2′-hydroxyphenylbenzotrazole, 2-(3′-dodecyl-2′-hydroxy-5′-methylphenyl)benzotrazole, 2-(3′-tert-butyl-2′-hydroxy-5′-(2-isooctyloxy-carbonylethyl)phenylbenzotriazole, 2,2′-methylenebis[4-(1,1,3,3-tetramethylbuty)-8-benzo-triazole-2-ylphenol]; the transesterification product of 2-[3′-tert-butyl-5′-(2-methoxycarbonyl-ethyl)-2′-hydroxyphenyl]-2H-benzotriazole with polyethylene glycol 300; [R′—CH₂—CH₂—CO—O—CH₂—CH₂-]₂, where R′=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbuty)phenyl]benzotriazole; 2-[2′-hydroxy-3′-(1,1,3,3-tetramethylbutyl)-5′-(α,α-dimethylbenzyl)phenyl]benzotrazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)-resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates/Cinnamates, for example ethyl α-cyano-β,β-diphenylacrylate, isooctyl α-cyano-β,β-diphenylacrylate, methyl α-carbomethoxycinnamate, methyl α-cyano- β-methyl-p-methoxy-cinnamate, butyl α-cyano- β-methyl-p-methoxycinnamate, methyl α-carbomethoxy-p-methoxy-cinnamate, N-(p-carbomethoxy- p-cyanovinyl)-2-methylindoline and neopentyl tetra(α-cyano-0, -diphenylacrylate), or sterically hindered acrylates such as disclosed in EP-A-3587425, like for instance (2E,2′E)-2,4,8,10-tetraoxaspiro[5.5]undecane-3,9-diylbis(2-methylpropane-2,1-diyl) bis(2-cyano-3-(3,4-dimethoxyphenyl)acrylate) [CAS Reg. No. 2233585-18-5], or a similar derivative, wherein the one of the two OCH₃ groups (methoxy) of each of the (2-cyano-3-(3,4-dimethoxyphenyl)acrylate)moiety is respectively substituted with a OC₆H₁₃ group, resulting in a bis(2-cyano-3-(3-methoxy-4-hexyloxyphenyl)acrylate) derivative.

2.5. Nickel compounds, for example nickel complexes of 2,2′-thiobis[4-(1,1,3,3-tetramethyl-butyl)phenol], such as the 1:1 or 1:2 complex, with or without additional ligands such as n-butyl-amine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzyl-phosphonic acid, nickel complexes of ketoximes, e.g. of 2-hydroxy-4-methylphenylundecyl-ketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperdyl)sebacate, bis(1,2,2,6,6-pentamethyl-4-piperidy) n-butyl-3,5-di-tert-butyl-4-hydroxybenzylmalonate, the condensate of 1-(2-hydroxyethyl)-2,2,6,6-tetramethyl-4-hydroxypiperdine and succinic acid, linear or cyclic condensates of N,N′-bis(2,2,6,6-tetramethyl-4-piperdyl)hexamethylenediamine and 4-tert-octylamino-2,6-dichloro-1,3,5-triazine, tris(2,2,6,6-tetramethyl-4-piperidyl)nitrlotriacet-ate, tetrakis(2,2,6,6-tetramethyl-4-piperidyl)-1,2,3,4-butanetetracarboxylate, 1,1′-(1,2-ethanedi-yI-bis(3,3,5,5-tetramethylpiperazinone), 4-benzoyl-2,2,6,6-tetramethylpiperdine, 4-stearyloxy-2,2,6,6-tetramethylpiperidine, bis(1,2,2,6,6-pentamethylpiperdyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperid-4-yl)sebacate, bis(1-octyloxy-2,2,6,6-tetramethyl-piperd-4-yl)succinate, bis-[2,2,6,6-tetramethyl-1-(undecyloxy)-piperdin-4-yl]carbonate, linear or cyclic condensates of N,N′-bis(2,2,6,6-tetramethyl-4-piperidyl)-hexamethylenediamine and 4-morpholino-2,6-dichloro-1,3,5-triazine, the condensate of 2-chloro-4,6-bis(4-n-butylamino-2,2,6,6-tetramethylpiperdyl)-1,3,5-triazine and 1,2-bis(3-aminopropylamino)ethane, the conden-sate of 2-chloro-4,6-di-(4-n-butylamino-1,2,2,6,6-pentamethylpiperidy-1,3,5-triazine and 1,2-bis(3-aminopropyl-amino)ethane, 8-acetyl-3-dodecyl-7,7,9,9-tetramethyl-1,3,8-triazaspiro[4.5]-decane-2,4-dione, 3-dodecyl-1-(2,2,6,6-tetramethyl-4-piperdyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperdine, a condensate of N,N′-bis(2,2,6,6-tetramethyl-4-piperid-yl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanedi-amine and 2,4,6-tichloro-1,3,5-triazine as well as N,N-dibutylamine and 4-butylamino-2,2,6,6-tetramethylpiperidine (CAS Reg. No. [192268 64-7]); reaction products of N6,N6′-hexane-1,6-diylbis[N2,N4-dibutyl-N2,N4,N6-tris(2,2,6,6-tetramethylpiperidin-4-yl)-1,3,5-triazine-2,4,6-triamine], butanal and hydrogen peroxide; N-(2,2,6,6-tetramethyl-4-piperdyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxypheny)-ethene, N,N′-bis-formyl-N,N′-bis(2,2,6,6-tetramethyl-4-piperidyl)hexamethylenediamine, a diester of 4-methoxymethyl-enemalonic acid with 1,2,2,6,6-pentamethyl-4-hydroxy-piperidine, poly[methylpropyl-3-oxy-4-(2,2,6,6-tetramethyl-4-piperdyl)]siloxane, a reaction product of maleic acid anhydride-a-olefin copolymer with 2,2,6,6-tetramethyl-4-aminopiperidine or 1,2,2,6,6-pentamethyl-4-amino-piperidine, a mixture of oligomeric compounds which are the formal condensation products of N,N′-bis-(2,2,6,6-tetramethyl-1-propoxy-piperidin-4-yI-hexane-1,6-diamine and 2,4-dichloro-8-{n-butyl-(2,2,6,6-tetramethyl-1-propoxy-piperidin-4-y)-amino}-[1,3,5]triazine end-capped with 2-chloro-4,6-bis-(di-n-butylamino)-[1,3,5]triazine, a mixture of oligomeric compounds which are the formal condensation products of N,N′-bis-(2,2,6,6-tetramethyl-piperidin-4-y)-hexane-1,6-di-amine and 2,4-dichloro-8-{n-butyl-(2,2,6,6-tetramethyl-piperidin-4-yl)-amino}-[1,3,5]triazine end-capped with 2-chloro-4,6-bis-(di-n-butylamino)-[1,3,5]triazine, (N2,N4-dibutyl-N2,N4-bis(1,2,2,6,6-pentamethyl-4-piperdiny-8-(1-pyrrolidinyl)-[1,3,5]-triazine-2,4-diamine, 2,4-bis[N-(1-cyclohexyloxy-2,2,6,6-tetramethylpiperidine-4-y)-N-butylamino]-8-(2-hydroxyethy)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trmethyl-2-morpholinone, Sanduvor 3058 (Clariant; CAS Reg. No. [106917-31-1]), 5-(2-ethylhexanoyl)-oxymethyl-3,3,5-trmethyl-2-morpholinone, the reaction product of 2,4-bis-[(1-cyclo-hexyloxy-2,2,6,6-piperidine-4-y)butylamino]-8-chloro-s-triazine with N,N′-bis-(3-amino-propyl)ethylenediamine), 1,3,5-tris(N-cyclohexyl-N-(2,2,6,6-tetra-methyl-piperazine-3-one-4-y)amino)-s-triazine, 1,3,5-tris(N-cyclohexyl-N-(1,2,2,6,6-pentamethylpiperazine-3-one-4-yl)-amino)-s-triazine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-tiazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)-oxalyl dihydrazide, N,N′-bis(salicyloyl)thiopropionyl dihydrazide.

4. Phosphites and phosphonates such as Tris alkyl (C12-C15) phosphite, Triisodecyl phosphite, Triisotridecyl phosphite, Dioleyl Hydrogen phosphite, Triisooctyl Phosphite, Heptakis (dipropyleneglycol) Triphosphite, Trilauryl Trithio Phosphite, Tris (Dipropyleneglycol) Phosphite, Dimethyl hydrogen phosphite, Dibutyl hydrogen phosphite, Dilauryl hydrogen phosphite, Tri-C12-C14-phosphite or Bis(2-ethylhexyl) hydrogen phosphite. Other phosphites and phosphonates, which are for instance liquid ones such as Di-n-octyl hydrogen phosphite or Di-iso-octyl hydrogen phosphite, or for example trphenyl phosphite, tris(nonylphenyl) phosphite, Phenyldiisodecyl phosphite, Diphenylisodecyl phosphite, [Triphenyl phosphite, polymer with 1,4-cyclohexanedimethanol and polypropylene glycol, C10-16 alkyl esters (CAS Reg. No. 1821217-71-3)]. Further optional phosphites or phosphonates additives are for instance Alkyl (C12-C15) bisphenol A phosphite, Alkyl (C10) bisphenol A phosphite, Poly (dipropyleneglycol) phenyl phosphite, Tris (tridecyl) phosphite, Diphenyl phosphite, Dodecyl nonylphenol phosphite blend, Phenyl Neopentylene Glycol Phosphite, Poly 4,4′ Isopropylidenediphenol-C10 Alcohol Phosphite, Poly 4,4′ Isopropylidenediphenol-C12-15 Alcohol Phosphite, diphenylalkyl phosphites, phenyldialkyl phosphites, C12-C18 alkyl bis[4-(1-methyl-1-phenyl-ethyl)phenyl]phosphite, C12-C18 alkenyl bis[4-(1-methyl-1-phenyl-ethyl)phenyl]phosphite, bis[4-(1-methyl-1-phenyl-ethyl)phenyl][(E)-octadec-9-enyl]phosphite, decyl bis[4-(1-methyl-1-phenyl-ethyl)phenyl]phosphite, didecyl [4-(1-methyl-1-phenyl-ethyl)phenyl]phosphite, [4-(1-methyl-1-phenyl-ethyl)phenyl]bis[(E)-octadec-9-enyl]phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-8-methylphenyl)pentaerythritol diphosphite, bis(2,4,6-tris(tert-butylphenyl)pentaerythritol diphosphite, [2-tert-butyl-4-[1-[5-tert-butyl-4-di(trdecoxy)phosphanyloxy-2-methyl-phenyl]butyl]-5-methyl-phenyl]ditridecyl phosphite, tristearyl sorbitol triphosphite, a mixture of at least two different tris(mono-C₁-C₈-alkyl)phenyl phosphites such as for example mentioned in U.S. Pat. No. 7,488,410 B2 as products of examples 1 and 2, a mixture of phosphites comprising at least two different tris(amylphenyl) phosphites such as for example mentioned in U.S. Pat. No. 8,008,383 B2 as mixtures 14, 15, 16, 17, 18, 19, 20, 21, 22, 23, 24, 25 and 26, a mixture of a least four different phosphites comprising tis[4-(1,1-dimethylpropyl)phenyl]phosphite, [2,4-bis(1,1-dimethylpropy)phenyl]bis[4-(1,1-dimethylpropyl)phenyl]phosphite, bis[2,4-bis(1,1-dimethylpropy)phenyl][4-(1,1-dimethylpropyl)phenyl]phosphite and tris[2,4-bis(1,1-dimethylpropy)phenyl]phosphite, a mixture of phosphites comprising at least two different tris(butylpheny) phosphites such as for example mentioned in U.S. Pat. No. 8,008,383 B2 as mixtures 34, 35, 36, 37, 38, 39 and 40, an oxyalkylene-bridged bis-(di-Ce-aryl) diphosphite or an oligomeric phosphite obtainable by condensation under removal of hydrogen chloride of (i) a trichlorophosphane, with (ii) a dihydroxyalkane interrupted by one or more oxygen atoms and with (iii) a mono-hydroxy-Ce-arene such as for example mentioned in U.S. Pat. No. 8,304,477 B2 as products of examples 1, 2, 3, 4, 5, 6, 7, 8, 9, 10, 11, 12, 13, 14, 15, 16 and 17, a polymeric phosphite obtainable by transesterification under removal of phenol of (i) triphenyl phosphite with (ii) a dihydroxyalkane optionally interrupted by one or more oxygen atoms and/or a bis-(hydroxyalkyl)(alkyl)amine and with (iii) a mono-hydroxyalkane optionally interrupted by one or more oxygen atoms such as for example mentioned in U.S. Pat. No. 8,563,637 B2 as products of examples 1, 2, 3, 4, 5, 6, 7, 8, 9, 10 and 11, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocine, bis(2,4-di-tert-butyl-6-methylphenyl)methylbis(2,4-di-tert-butyl-6-methylpheny)methyl phosphite, bis(2,4-di-tert-butyl-6-methylpheny)ethyl phosphite, 6-fluoro-2,4,8,10-tetra-tert-butyl-12-methyl-dibenz[d,g]-1,3,2-dioxaphosphocine, 1,3,7,9-tetra-tert-butyl-11-octoxy-5H-benzo[d][1,3,2]benzodioxaphosphocine, 2,2′,2″-nitrilo[triethyltris(3,3′,5,5′-tetra-tert-butyl-1,1′-biphenyl-2,2′-diy)phosphite], phosphorous acid, triphenyl ester, polymer with a -hydro- w-hydroxypoly[oxy(methyl-1,2-ethanediyl)], C₁₀-16-alkyl esters (CAS Reg. No. [1227937-46-3]), 2-ethylhexyl(3,3′,5,5′-tetra-tert-butyl-1,1′-biphenyl-2,2′-diy)phosphite, 5-butyl-5-ethyl-2-(2,4,6-tri-tert-butylphenoxy)-1,3,2-dioxaphosphirane, phosphorous acid, mixed 2,4-bis(1,1-dimethylpropy)phenyl and 4-(1,1-dimethylpropyl)phenyl triesters (CAS Reg. No. [939402-02-5]).

The following phosphites are especially preferred: Tris(2,4-di-tert-butylpheny) phosphite (Irgafos*168, Ciba Specialty Chemicals Inc.), tris(no-nylphenyl) phosphite,

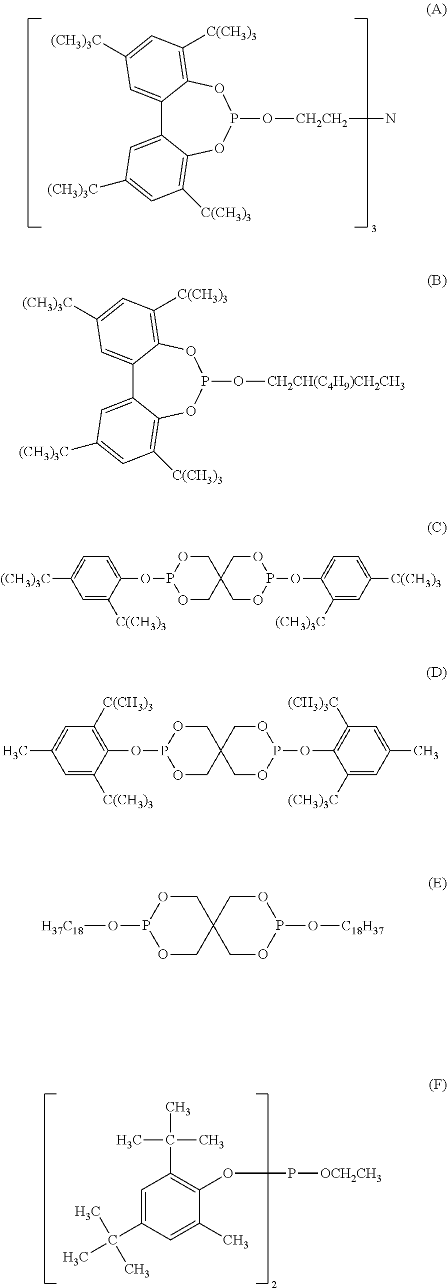

5. Hydroxylamines and amine N-oxides, for example N,N-dibenzylhydroxylamine, N,N-di-ethylhydroxylamine, N,N-dioctylhydroxylamine, N,N-dilaurylhydroxylamine, N,N-ditetradecyl-hydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine, N,N-bis-(hydrogenated rape-oil alkyl)-N-methyl-amine N-oxide or trialkylamine N-oxide.

6. Nitrones, for example N-benzyl-alpha-phenylnitrone, N-ethyl-alpha-methylnitrone, N-octyl-alpha-heptylnitrone, N-lauryl-alpha-undecylnitrone, N-tetradecyl-alpha-trdecylnitrone, N-hexadecyl-alpha-pentadecylnitrone, N-octadecyl-alpha-heptadecylnitrone, N-hexadecyl-alpha-heptadecylnitrone, N-octadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine (optionally from vegetable source).

7. Thiosynergists, for example dilauryl thiodipropionate, dimistryl thiodipropionate, distearyl thiodipropionate and pentaerythritol tetrakis-[3-(n-lauryl)-propionic acid ester].

8. Peroxide scavengers, for example esters of a-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(b-dodecylmercapto)propionate.

10. Polyamide stabilizers, for example copper salts in combination with iodides and/or phos-phorus compounds and salts of divalent manganese.

11. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate, zeolithes, hydrotalcites, hydrocaluminates, zinc oxide.

12. Nucleating agents, for example inorganic substances, such as talcum, metal oxides, such as titanium dioxide or magnesium oxide, phosphates including phosphate salts such as 2,2′-methylene-bis(4,6-di-tert-butylphenol) phosphate sodium salt, 2,2′-methylene-bis(4,6-di-tert-butylphenol) phosphate aluminium salt or 2,2′-methylene-bis(4,6-di-tert-butylphenol) phosphate lithium salt, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate, 1,2-cyclohexane dicarboxylic acid calcium salt, bicycio[2.2.1]heptane-2,3-dicarboxylic acid disodium salt; polymeric compounds, such as ionic copolymers (ionomers), triamino benzene derivatives such as 1,3,5-tris[2,2-dimethylpropionylamine]benzene, zinc glycerolate and nonytol derivatives. Especially preferred are 1,3:2,4-bis(3′,4′-dimethylbenzylidene)sorbitol, 1,3:2,4-di(paramethyl-dibenzylidene)sorbitol, and 1,3:2,4-di(benzylidene)sorbitol.

13. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.

14. Other additives, for example plasticisers, lubricants, emulsifiers, pigments, rheology additives, catalysts, flow-control agents, optical brighteners, flameproofing agents, antistatic agents and blowing agents, heat stabilizers, anti-fog agents, anti-mist agents, anti-blocking additives, slip agents, anti-scratch agents.

15. Benzofuranones and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839 or EP-A-0591102, WO2015/121445, WO2017/025431, or 5,7-di-tert-butyl-3-(4-hydroxyphenyl)-3H-benzofuran-2-one, 5,7-di-tert-butyl-3-[4-(2-hydroxyethoxy)phenyl]-3H-benzofuran-2-one, 5,7-di-tert-butyl-3-[4-[2-[2-[2-[2-(2-hydroxyethoxy)ethoxy]ethoxy]ethoxy]ethoxy]phenyl]-3H-benzofuran-2-one, 3-[4-(2-acetoxy-ethoxy)phenyl]-5,7-di-tert-butylbenzofuran-2-one, 5,7-di-tert-butyl-3-[4-(2-stearoyloxy-ethoxy)phenyl]benzofuran-2-one, 3,3′-bis[5,7-di-tert-butyl-3-(4-[2-hydroxyethoxy]-phenyl)benzofuran-2-one], 5,7-di-tert-butyl-3-(4-ethoxyphenyl)benzofuran-2-one, 3-(4-acetoxy-3,5-dimethylpheny)-5,7-di-tert-butylbenzofuran-2-one, 3-(3,5-dimethyl-4-pivaloyloxypheny)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetoxy-4-(1,1,3,3-tetramethyl-butyl)-pheny)-5-(1,1,3,3-tetramethyl-butyl)-benzofuran-2-one, [6-[6-[6-[2-[4-(5,7-di-tert-butyl-2-oxo-3H-benzofuran-3-y)phenoxy]ethoxy]-6-oxo-hexoxy]-6-oxo-hexoxy]-6-oxo-hexyl]6-hydroxyhexan-oate, [4-tert-butyl-2-(5-tert-butyl-2-oxo-3H-benzofuran-3-y)phenyl]benzoate, [4-tert-butyl-2-(5-tert-butyl-2-oxo-3H-benzofuran-3-yl)phenyl]3,5-di-tert-butyl-4-hydroxy-benzoate and [4-tert-butyl-2-(5-tert-butyl-2-oxo-3H-benzofuran-3-yl)phenyl]3-(3,5-di-tert-butyl-4-hydroxy-phenylpropanoate.

16. Flame retardants

16.1. Phosphorus containing flame retardants including reactive phosphorous containing flame retardants, for example tetraphenyl resorcinol diphosphite (Fyrolflex RDP, RTM, Akzo Nobel), tetrakis(hydroxymethyl)phosphonium sulphide, triphenyl phosphate, diethyl-N,N-bis(2-hy-droxyethyl)-aminomethyl phosphonate, hydroxyalkyl esters of phosphorus acids, alkylphosphate oligomers, ammonium polyphosphate (APP), resorcinol diphosphate oligomer (RDP), phosphazene flame retardants or ethylenediamine diphosphate (EDAP).

16.2. Nitrogen containing flame retardants, for example melamine-based flame retardants, isocyanurates, polyisocyanurate, esters of isocyanuric acid, like tris-(2-hydroxyethyl)iso-cyanurate, tris(hydroxymethyl)isocyanurate, tris(3-hydroxy-n-propyl)isocyanurate, triglycidyl isocyanurate, melamine cyanurate, melamine borate, melamine phosphate, melamine pyro-phosphate, melamine polyphosphate, melamine ammonium polyphosphate, melamine am-monium pyrophosphate, dimelamine phosphate, dimelamine pyrophosphate, benzoguanamine, allantoin, glycoluril, urea cyanurate, a condensation product of melamine from the series melem, melam, melon and/or a higher condensed compound or a reaction product of melamine with phosphoric acid or a mixture thereof.

16.3. Organohalogen flame retardants, for example polybrominated diphenyl oxide, decabromodiphenyl oxide (DBDPO), tris[3-bromo-2,2-bis(bromomethyl)propyl]phosphate (PB 370, (RTM, FMC Corp.)), tris(2,3-dibromopropyl)phosphate, chloroalkyl phosphate esters such as tris(chloropropyl)phosphate, tris(2,3-dichloropropyl)phosphate, tris(1,3-dichloro-2-propyl)phosphate (Fyrol FR 2 (RTM ICL)), oligomeric chloroalkyl phosphate, chlorendic acid, tetrachlorophthalic acid, tetrabromophthalic acid, poly-b-chloroethyl triphosphonate mixture, tetrabromobisphenol A-bis(2,3-dibromopropyl ether) (PE68), brominated epoxy resin, brominated aryl esters, ethylene-bis(tetrabromophthalimide) (Saytex BT-93 (RTM, Albemarle)), bis(hexachlorocyclopentadieno) cyclooctane (Declorane Plus (RTM, Oxychem)), chlorinated paraffins, octabromodiphenyl ether, hexachlorocyclopentadiene derivatives, 1,2-bis(tribromophenoxy)ethane (FF680), tetrabromobisphenol A (Saytex RB100 (RTM, Albemarle)), ethylene bis-(dibromonorbomanedicarboximide) (Saytex BN-451 (RTM, Albemarle)), bis-(hexachlorocycloentadeno)cyclooctane, PTFE, tris (2,3-dibromopropyl) isocyanurate or ethylene-bis-tetrabromophthalimide. Some of the halogenated flame retardants mentioned above are routinely combined with an inorganic oxide synergist. Some of the halogentated flame retardants mentioned above can be used in combination with triaryl phosphates (such as the propylated, butylated triphenyl phosphates) and the like and/or with oligomeric aryl phosphates (such as resorcinol bis(diphenyl phosphate), bisphenol A bis(diphenyl phosphate), neopentyiglycol bis(diphenyl phosphate)) and the like.

16.4. Inorganic flame retardants, for example aluminium trihydroxide (ATH), boehmite (AIOOH), magnesium dihydroxide (MDH), zinc borates, CaCO₃, organically modified layered silicates, organically modified layered double hydroxides, and mixtures thereof. In regard to the synergistic combination with halogenated flame retardants, the most common inorganic oxide synergists are zinc oxides, antimony oxides like Sb₂O₃ or Sb₂O₅ or boron compounds.

### EXAMPLES

Compound 1: N,N′-bis(2,2,6,6-tetramethyl-4-piperidyl)-N,N′-diformylhexamethylenediamine
Compound 2: 2-[4,6-Bis(2,4-dimethylphenyl)-1,3,5-triazin-2-yl]-5-(octyloxy) phenol
Compound 3: phenol, 2-[4,6-bis([1,1 ′-biphenyl]-4-yl)-1,3,5-triazin-2-y]-5-[(ethylhexyl)oxy]
Compound 4: 5-[(2-ethylhexyl)oxy]-2-(4-{4-[(2-ethylhexyl)oxy]-2-hydroxyphenyl}-6-(4-methoxyphenyl)-1,3,5-triazin-2-yI)phenol
Compound 5: 2-[4,6-bis(2,4-dimethylphenyl)-1,3,5-triazin-2-yl]-5-[3-[(2-ethylhexyl)oxy]-2-hydroxypropoxy]-phenol
Compound 6: Decanedioic acid, bis(2,2,6,6-tetramethyl-1-(octyloxy)-4-piperdinyl) ester, reaction products with 1,1-dimethylethylhydroperoxide and octane
Compound 7: Butanedioic acid, dimethylester, polymer with 4-hydroxy-2,2,6,6-tetramethyl-1-piperidine ethanol with Mn of 3100-4000 g/mol
Compound 8: phenol, 2-(4,6-Diphenyl-1,3,5-triazin-2-yl)-5-hexyloxy
Compound 9: 2,4,6-trichloro-1,3,5-triazine, reaction products with N-butyl-1-butanamine and N-butyl-2,2,6,6-tetramethyl-4-piperidinamine
Compound 10: Propanoic acid. 2-(4-(4,6-bis((1,1′-biphenyl)-4-yl)-1,3,5-triazin-2-yl)-3-hydroxyphenoxy)-, isooctyl ester
   Examples with ABS

The examples related to Acrylonitrile Butadiene Styrene (ABS) all contained a base stabilization consisting of 0.02% octadecyl-3-(3,5-di-tert-butyl-4-hydroxyphenyl)-propionate, 0.08% tris(2,4-di-tert-butylphenyl)phosphite and 0.15% Compound 1.

Process: The additives, all in powder form, were dry blended with grinded ABS (Terduran® GP-22, density 1040 kg/m³, melt volume rate 19 cm³/10 min at 220° C./10 kg) in a high-speed mixer during 2 minutes at 3000 rpm to provide the formulations. Additive levels are reported in % by weight, based on the weight of the ABS. The mixtures were pre-dried at 60° C. during 12 hours in a vacuum oven.

The dry blends were melt-extruded into pellets in a co-rotating twin-screw extruder with screw diameter of 25 mm and length to diameter ratio of 42. The screw rotating speed was 160 rpm, the material throughput was 7 kg/hour, the zone settings were 160° C./170° C./180° C./190° C./200° C./210° C./220° C./220° C. and the melt temperature was 215° C. The extruder feeder was under nitrogen blanket (40 ml/min). The extrudate was directly cooled in water after exiting the extruder nozzle. The granulation of the extrudate took place under air. The obtained pellets were pre-dried at 60° C. during 12 hours in a vacuum oven.

The pre-dried pellets were then injection molded on an injection molding machine with clamping force of 500 kN, the zone settings were 45° C./190° C./200° C./210° C./220° C./220° C. The nozzle temperature was 220° C. The mold temperature was 60° C. on both sides. Plaques of dimensions 2 mm×44 mm×68 mm were obtained.

The plaques were then exposed in an Atlas xenon weatherometer for long-term accelerated weathering with parameters set in DIN EN IS0105 B06 (xenon light, irradiance 1.20 W/(m²-nm) @420 nm. Dry bulb temperature was 65° C., black standard temperature was 100° C., the relative moisture was 30%, no water spraying was used). Measurements were made at various times, given in hours in the below Tables.

Measurement methods:

Color coordinate L*, in CIELAB units, according to ISO 4582, where a zero defines black and 100 defines white. The higher it is, the better. deltaE*, in CIELAB units, is taken as the square root of the squares of the differences in the L*, a* and b* CIELAB color coordinates at time of recall minus time zero, as defined in ISO 11664-4. The lower it is, the better. The results outlined in the Table 1 are given after 519 hours exposure.

TABLE 1

| | | Color | Color |
|---|---|---|---|
| | | coordinate | difference |
| | Additives | L* | delta E* |
| Comparative Example 1 | 0.25% Compound 2 | 93.93 | 2.51 |
| Example 1 | 0.20% Compound 2 | 94.17 | 1.85 |
| | 0.05% Compound 3 | | |

The above results showed that the L* color coordinates were significantly higher and that the deltaE* color differences were significantly lower for the ABS stabilized with the combination of two additives in Example 1.

### Examples with Polyvinylbutyral (PVB)

As polymer, a low viscous PVB (Mowital BA 20S), with a medium degree of acetalization, was used. First, a mixture consisting of 74.965% PVB, 24.987% diethylene glycol bis-2-ethylhexanoate /triethylene glycol bis-2-ethylhexanoate, 0.022% magnesium acetate tetrahydrate, and 0.026% magnesium(II) 2-ethylbutyrate was dry-blended in a high-speed mixer.

The compounding took place on a Brabender kneader, with (100-x)% of the dry-blend mixture plus x % of additives as given in the below Tables. The kneader was under nitrogen blanket. The temperature was set at 135° C., the rotating speed of the mixing elements at 30 rotations per minute and the kneading duration set at 10 minutes. The amount of each kneaded compound in the Brabender kneader was 48 grams.

Further to that, the kneaded compounds were compressed into plaques in a press set at 185° C. with pre-time of 1 minute at 5 bar and press time of 2 minutes at 250 bar. The cooling took place in a second press during 1.5 minute at room temperature. Teflon foils were placed on each side of the plates of the press to avoid sticking of the compounds to the metal. Plaques of 0.2 mm thickness were obtained.

The plaques were then exposed in an Atlas xenon weatherometer for long-term accelerated weathering with parameters set in ASTM G 155 (xenon light, irradiance 0.30 W/(m2·nm) @340 nm, following the settings of cycle 4: the dry bulb temperature was 35° C., the black panel temperature was 55° C., the relative moisture was 55%, no water spraying was used).

Measurements were made at various times, given in hours in the below Tables.

Measurement methods:

The clarity and the haze in % were measured according to ASTM D1003. The higher the clarity, the better, the lower the haze, the better.

Yellowness Index, without unit, according to ASTM E313. The lower it is, the better. deltaE*, in CIELAB units, is taken as the square root of the squares of the differences in the L*, a* and b* CIELAB color coordinates at time of recall minus time zero, as defined in ISO 11664-4. The lower it is, the better.

TABLE 2
Clarity [%] over exposure according
to ASTM G 155 cycle 4, 4007 hours

| | Additives | Clarity [%] |
|---|---|---|
| Comparative example 3 | — | 92.7 |
| Comparative example 4 | 0.075% Compound 4 | 85.9 |
| Example 3 | 0.067% Compound 4 | 93.8 |
| | 0.008% Compound 3 | |
| Example 4 | 0.067% Compound 4 | 95.1 |
| | 0.008% Compound 2 | |

The above results showed that the values of clarity were significantly higher for the PVB stabilized with the Examples 3 and 4.

TABLE 3
Haze [%] over exposure according
to ASTM G 155 cycle 4, 4007 hours

| | Additives | Haze [%] |
|---|---|---|
| Comparative example 5 | — | 92.4 |
| Comparative example 6 | 0.050% Compound 5 | 89.0 |
| | 0.025% Compound 6 | |
| Example 5 | 0.045% Compound 5 | 81.1 |
| | 0.005% Compound 3 | |
| | 0.025% Compound 6 | |

The above results showed that the values of the haze were significantly lower for the PVB stabilized with the Example 5.

TABLE 4
Yellowness Index over exposure according
to ASTM G 155 cycle 4, after 4007 hours

| | Additives | Yellowness Index |
|---|---|---|
| Comparative example 7 | 0.075% Compound 4 | 9.5 |
| Example 6 | 0.067% Compound 4 | 7.7 |
| | 0.008% Compound 3 | |
| Example 7 | 0.067% Compound 4 | 4.8 |
| | 0.008% Compound 2 | |

The above results showed that the values of the yellowness index were significantly lower for the PVB stabilized with the Examples 6 and 7.

TABLE 5
Yellowness Index over exposure according
to ASTM G 155 cycle 4, after 500 hours

| | Additives | Yellowness Index |
|---|---|---|
| Comparative example 8 | 0.050% Compound 4 | 8.3 |
| | 0.025% Compound 6 | |
| Example 8 | 0.045% Compound 4 | 4.8 |
| | 0.005% Compound 2 | |
| | 0.025% Compound 6 | |

The above results showed that the values of the yellowness index were significantly lower for the PVB stabilized with the Example 8.

TABLE 6
DeltaE* [CIELAB units] over exposure according
to ASTM G 155 cycle 4, 4007 hours

| | | DeltaE* color |
|---|---|---|
| | Additives | difference |
| Comparative example 9 | 0.075% Compound 4 | 7.9 |
| Example 9 | 0.067% Compound 4 | 6.0 |
| | 0.008% Compound 3 | |
| Example 10 | 0.067% Compound 4 | 5.6 |
| | 0.008% Compound 2 | |

The above results showed that the deltaE* color differences were significantly lower for the PVB stabilized with the Examples 9 and 10.

### Examples with PET Fibers

### Process:

All the PET fibers tested in this section contained a base stabilization consisting of 0.02% pentaerythritol tetrakis(3-(3,5-di-tert-butyl-4-hydroxyphenyl) propionate) and 0.08% bis-(2,4-di-tert-butylphenol)pentaerythritol diphosphite. The additives, all in powder form or if not in powder form specifically grinded at lab-scale to obtain them in powder form, were dry blended with polyethylene terephthalate (PET), also pre-grinded into powder (Invista 4048, having an intrinsic viscosity (1% solution in dichloroacetic acid) of 0.645) and <1.1% wt. of diethylene glycol) in a high-speed mixer during 2 minutes at 3000 rpm to provide the formulations. Additive levels are reported in % by weight, based on the weight of the PET.

The mixtures were pre-dried at 120° C. during 8 hours in a vacuum oven. The moisture level after pre-drying, measured by Karl-Fischer titration, was 0.004%. The dry blends were melt-extruded into pellets in a co-rotating twin-screw extruder with screw diameter of 25 mm and length to diameter ratio of 47. The screw rotating speed was 160 rpm, the material throughput was 15 kg/hour, the zone settings were 30° C./230° C./240° C./250° C./260° C./260° C. /260° C./260° C./260° C./260° C./260° C. and the melt temperature was 271° C. The extrudate was directly cooled in water after exiting the extruder nozzle. The granulation of the extrudate took place under air. Pellets were obtained.

The pellets were pre-dried and recrystallized at 160° C. during 3 hours in a vacuum oven. The pre-dried and recrystallized pellets were then melt spun on a melt spinning machine with a single-screw extruder, with screw rotating speed at 76 rotations per minute, and with temperature zones set at 250° C./260° C./270° C./280° C./190° C. The melt temperature was 303° C. The temperature of the head was set at 290° C. The nozzle contained 40 holes, to obtain yams of 40 filaments of 4.5 denier each. The speed on the godet rolls were at 238 m/min, 300 m/min, 950 m/min and 950 m/min respectively on the godet rolls 1, 2, 3 and 4. The godet rolls 2 and 3 were heated at 100° C. and godet roll 4 at 40° C.: The winding speed of the winding roll was at 1050 m/min. The stretch ratio was 1:3.2.

The PET fibers were then rolled up on PMMA plaques to have one layer of parallel PET fibers parallel to each other. The rolled-up PET fibers were then exposed in Atlas xenon weatherometers for long-term accelerated weathering tests with parameters set in DIN EN ISO105 B04 and DIN EN ISO105 B06. The parameters according to DIN EN ISO105 B04 were xenon light, irradiance 42 W/(m2·nm) @300-400 nm, equivalent to 0.36 W/(m2·nm) @340 nm, dry bulb temperature 38° C., black standard temperature 60° C., relative moisture 10%, cycles of 29 minutes with irradiance plus 1 minute with irradiance and water spraying. The parameters according to DIN EN ISO105 B06 were xenon light, irradiance 1.20 W/(m2·nm) @420 nm, dry bulb temperature 65° C., black standard temperature 100° C., relative moisture 30%, no water spraying was used. The titles of each of the below Tables mention which weathering exposure was used. Measurements were made at various times, given in hours in the below Tables.

Measurement methods: The PET fibers, non-exposed and exposed, were submitted to a tensile strength test on one yam after conditioning during 48 hours at room temperature and 55% rel. hum. The tensile tests took place at 100 mm/min traverse speed. The maximum force was recorded and the forces were normalized at 100% at time zero. The higher the retention is over time, the better.

The results outlined in the below Tables are given after 519 hours exposure, as it is shown in the columns on the right.

TABLE 7
Maximum force [%] over exposure according to DIN
EN ISO 105 B04, normalized at 100% at time zero.

| | Additives | 0 hour | 250 h | 500 h |
|---|---|---|---|---|
| Comparative | 1% Compound 2 | 100 | 62 | 47 |
| example 10 | 0.1% Compound 7 | | | |
| Example 11 | 0.875% Compound 2 | 100 | 84 | 63 |
| | 0.125% Compound 3 | | | |
| | 0.10% Compound 7 | | | |
| Example 12 | 0.75% Compound 2 | 100 | 82 | 53 |
| | 0.25% Compound 3 | | | |
| | 0.10% Compound 7 | | | |
| Example 13 | 0.75% Compound 2 | 100 | 63 | 57 |
| | 0.25% Compound 8 | | | |
| | 0.10% Compound 7 | | | |
| Example 14 | 0.5% Compound 2 | 100 | 77 | 60 |
| | 0.5% Compound 8 | | | |
| | 0.1% Compound 7 | | | |

The above results showed that the maximum forces were significantly higher for the PET fibers stabilized with the Examples 11-14.

TABLE 8
Maximum force [%] over exposure according to DIN
EN ISO 105 B06, normalized at 100% at time zero.

| | Additives | 0 hour | 73 hours |
|---|---|---|---|
| Comparative | 1% Compound 2 | 100 | 33 |
| example 11 | | | |
| Example 15 | 0.875% Compound 2 | 100 | 41 |
| | 0.125% Compound 3 | | |
| Example 16 | 0.5% Compound 2 | 100 | 35 |
| | 0.5% Compound 8 | | |

The above results showed that the maximum forces were significantly higher for the PET fibers stabilized with the Examples 15 and 16.

### Examples with PMMA

As polymer, a PMMA grade of melt volume rate of 6 cm³/10 min at 230° C. and 3.8 kg and density of 1.19 g/cm³, and Vicat softening temperature, according to method B/50 of ISO 306, of 103° C., was used (Plexiglas® 7N).

Solutions consisting of 40 g methylene chloride plus (10*(100-x)/100)g PMMA plus x*10/100 g additives were prepared by stirring during twelve hours (after at least two hours, a solution was obtained). Then the solution was cast onto a glass substrate and spread with a doctor blade of opening of 120 micron passing with a mobile system at a speed of 12 m/s. The cast solution was left for drying during 20 minutes on the glass plate, then it was removed and left to dry during 24 hours at room temperature and ambient moisture. The obtained solution cast films had a thickness of 30 micron.

The films were then exposed in an Atlas xenon weatherometer for long-term accelerated weathering with parameters set in DIN EN IS04892-2 cycle 1 or cycle 5. The exposure parameters according to DIN EN IS04892-2 cycle 1 were: xenon light, irradiance 60 W/m2 @300-400 nm, equivalent to 0.51 W/(m2·nm) @340 nm, the dry bulb temperature was 40° C., the black standard temperature was 65° C., the relative moisture was 50%. Cycles of 102 minutes irradiance plus 18 minutes irradiance and water spraying took place. The exposure parameters according to DIN EN IS04892-2 cycle 5 were: xenon light, irradiance 50 W/m2 @300-400 nm, equivalent to 0.43 W/(m2·nm) @340 nm, the dry bulb temperature was 38° C., the black standard temperature was 65° C., the relative moisture was 50%. No water spraying was used.

Measurement methods:

Measurements were made at various times, given in hours in the below Tables. The UV-vis absorbance of the non-exposed and exposed films was measured using a Lambda 20 UV-vis spectrum from Perkin Elmer. The optical absorbance spectra were taken, for the first below Table, at 290 nm, which corresponded to the wavelength at or close to the maximum absorbance, and, for the further below Tables, at the maximum located between 250 nm and 400 nm. The results of the decrease in percentage of the absorbance, taking 100% for the absorbance at time zero, were reported in the Tables below at various times. The higher the retention over time, the better.

The deltaE*, in CIELAB units, is taken as the square root of the squares of the differences in the L*, a* and b* CIELAB color coordinates at time of recall minus time zero, as defined in ISO 11664-4. The lower it is, the better.

TABLE 10
Absorbance [%] at 290 nm over exposure according to DIN EN ISO
4892-2 cycle 5, normalized at 100% at time zero, after 1100 hours.

| | Additives | Absorbance [%] |
|---|---|---|
| Comparative example 12 | 1.03% Compound 2 | 61 |
| | 1.00% Compound 9 | |
| Example 17 | 1.00% Compound 2 | 86 |
| | 0.03% Compound 3 | |
| | 1.00% Compound 9 | |

The above results showed that the absorbance was significantly higher for the PMMA film stabilized with the Example 17.

TABLE 11
deltaE* color difference [CIELAB units] over exposure
according to DIN EN ISO 4892-2 cycle 1, after 1784 hours

| | Additives | deltaE* |
|---|---|---|
| Comparative example 13 | 1.0% Compound 2 | 1.2 |
| Example 18 | 0.95% Compound 2 | 1.1 |
| | 0.05% Compound 3 | |
| | 1.00% Compound 9 | |
| Example 19 | 0.90% Compound 2 | 0.9 |
| | 0.10% Compound 3 | |
| | 1.00% Compound 9 | |

The above results showed that the deltaE* color differences were significantly lower for the PMMA films stabilized with the Examples 18 and 19.

TABLE 12
deltaE* color difference [CIELAB units] over exposure
according to DIN EN ISO 4892-2 cycle 5, after 1497 hours.

| | Additives | deltaE* |
|---|---|---|
| Comparative example 14 | 1.00% Compound 2 | 0.9 |
| | 1.00% Compound 9 | |
| Example 20 | 0.95% Compound 2 | 0.7 |
| | 0.05% Compound 3 | |
| | 1.00% Compound 9 | |

The above results showed that the deltaE* color difference was significantly lower for the PMMA film stabilized with the Example 20.

TABLE 13
Absorbance [%] at the maximum located between 250
nm and 400 nm, over exposure according to DIN EN ISO
4892-2 cycle 1, normalized at 100% at time zero, 3225 h.

| | Additives | Absorbance [%] |
|---|---|---|
| Comparative example 15 | 1.00% Compound 2 | 70 |
| | 1.00% Compound 9 | |
| Example 21 | 0.90% Compound 2 | 79 |
| | 0.10% Compound 3 | |
| | 1.00% Compound 9 | |

The above results showed that the absorbance was significantly higher for the PMMA film stabilized with the Example 21.

### Examples with PMMA

As polymer, a PMMA grade of melt volume rate of 1.4 cm³/10 min at 230° C. and 3.8 kg and density of 1.19 g/cm³, and Vicat softening temperature, according to method B/50 of ISO 306, of 103° C., was used (Plexiglas@7H).

The PMMA was cryo-grinded and vacuum-dried at 80° C. during 3 hours. The powder-powder mixing with the additives was carried out on a high-speed mixer at 80° C. The dry blends were melt-extruded into pellets in a co-rotating twin-screw extruder with screw diameter of 25 mm and length to diameter ratio of 46. The screw rotating speed was 150 rpm, the zone settings were 190° C./200° C./210° C. /220° C. /220° C./ 220° C./220° C./220° C. and the melt temperature was between 245° C. and 249° C. The extruder feeder was under nitrogen blanket (30 ml/min). The extrudate was directly cooled in water after exiting the extruder nozzle. The granulation of the extrudate took place under air. Pellets were obtained. The obtained pellets were dried in an air drier at 80° C. during 3 hours. The pre-dried pellets were then injection molded at 240° C. to obtain plaques with thickness of dimensions 2 mm×44 mm×68 mm.

Measurement method:_Yellowness Index, without unit, according to ASTM E313. The lower it is, the better.

TABLE 14
Initial yellowness index at 0 hour.

| | Additives | Yellowness index |
|---|---|---|
| Comparative example 16 | 0.5% Compound 9 | 13.2 |
| | 0.5% Compound 3 | |
| Example 22 | 0.5% Compound 9 | 12.1 |
| | 0.25% Compound 8 | |
| | 0.25% Compound 3 | |

The above results showed that the initial yellowing index was significantly lower for the PMMA plaque stabilized with the inventive Example 22.

### Examples with Polycarbonate

As polymer, a polycarbonate grade of density of 1.20 g/cm³, suitable for injection molding, was used (Lexan 115). Solutions consisting of 40 g methylene chloride plus (10*(100-x)/100)g PC plus x*10/100 g additives were prepared by stirring during twelve hours (after at least two hours, a solution was obtained). Then the solution was cast onto a glass substrate and spread with a doctor blade of opening of 120 micron passing with a mobile system at a speed of 12 m/s. The cast solution was left for drying during 20 minutes on the glass plate, then it was removed and left to dry during 24 hours at room temperature and ambient moisture. The obtained solution cast films had a thickness of 30 micron.

The films were then exposed in an Atlas xenon weatherometer for long-term accelerated weathering with parameters set in DIN EN IS04892-2 cycle 1. The exposure parameters according to DIN EN IS04892-2 cycle 1 were: xenon light, irradiance 60 W/m2 @300-400 nm, equivalent to 0.51 W/(m2·nm) @340 nm, the dry bulb temperature was 40° C., the black standard temperature was 65° C., the relative moisture was 50%. Cycles of 102 minutes irradiance plus 18 minutes irradiance and water spraying took place.

Measurement methods:

Measurements were made at various times, given in hours in the below Tables.

Yellowness Index, without unit, according to ASTM E313. The lower it is, the better. deltaE*, in CIELAB units, is taken as the square root of the squares of the differences in the L*, a* and b* CIELAB color coordinates at time of recall minus time zero, as defined in ISO 11664-4. The lower it is, the better

TABLE 15
Yellowness index over exposure according
to DIN EN ISO 4892-2 cycle 1, 3000 h

| | Additives | Yellowness index |
|---|---|---|
| Comparative example 17 | 1% Compound 2 | 7.4 |
| Example 23 | 0.5% Compound 3 | 6.1 |
| | 0.5% Compound 2 | |
| Example 24 | 0.5% Compound 10 | 6.2 |
| | 0.5% Compound 2 | |

The above results showed that the yellowing index values were significantly lower for the PC films stabilized with the Examples 23 and 24.

TABLE 16
deltaE* color difference [CIELAB units] over exposure
according to DIN EN ISO 4892-2 cycle 1, 3000 hours

| | Additives | deltaE* |
|---|---|---|
| Comparative example 18 | 1% Compound 8 | 3.6 |
| Example 25 | 0.5% Compound 3 | 3.1 |
| | 0.5% Compound 8 | |

The above results showed that the yellowing index was significantly lower for the PC film stabilized with the Example 25.

1. A method to further increase stability of a synthetic polymer against degradation induced by light comprising adding a co-stabilizer of the formula (1) 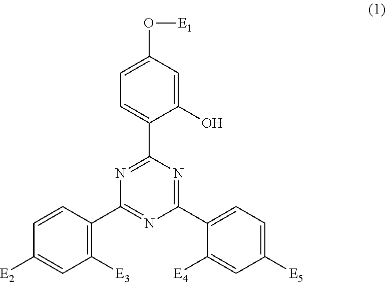
wherein
E₁ is hydrogen, C₁-C₁₈alkyl, C₁-C₁₈alkyl substituted by 1, 2 or 3 radicals selected from the group consisting of —OH, C₂-C₁₈alkenyloxy, —C(O)OX₁ and —OC(O)X₂ with X₁ and X₂ being independently C₁-C₁₈alkyl; C₃-C₅₀alkyl interrupted by oxygen or C₃-C₅₀hydroxyalkyl interrupted by oxygen; and
E₂, E₃, E₄ and E₅ are independently hydrogen, C₁-C₁₈alkyl, phenyl or phenyl substituted by 1, 2 or 3 C₁-C₄alkyl;
and a hydroxyphenyl triazine to the synthetic polymer, wherein the hydroxyphenyl triazine is different from the co-stabilizer of the formula (1).

2. The method according to claim 1, wherein the weight ratio of the co-stabilizer to the hydroxyphenyl triazine is from 2:1 to 1:150.

3. The method according to claim 1, wherein E1 is C₁-C₁₃ alkyl.

4. The method according to claim 1, wherein the co-stabilizer is selected from formulae (2), (3), or (4)

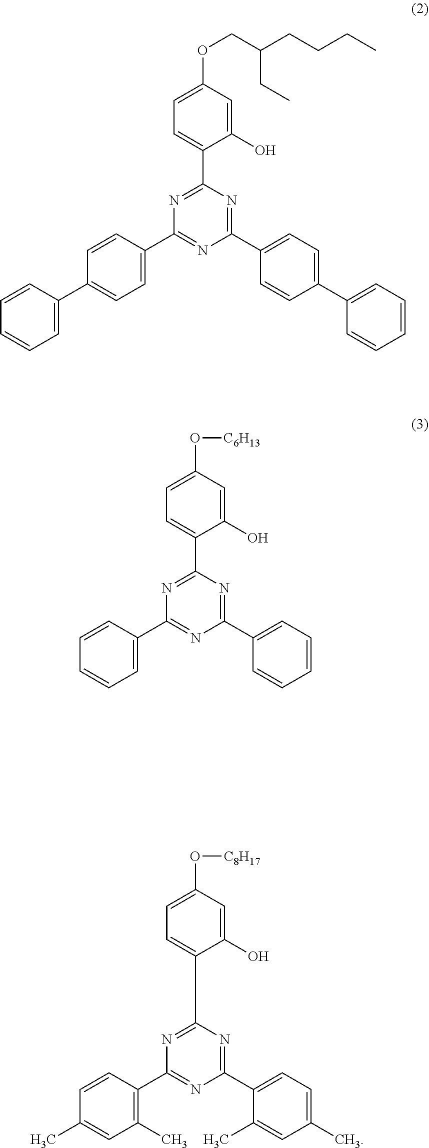

5. The method according to claim 1, wherein the synthetic polymers are polyethylene terephthalates, poly(methyl methacrylates), acrylonitrile butadiene styrene copolymers, polyvinylbutyral or polycarbonates.

6. The method according to claim 1, wherein the hydroxyphenyl triazine is at least one compound selected from the formulae (B-I) and (B-II) 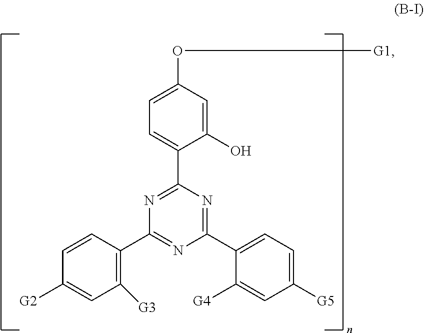
wherein G₂, G₃, G₄ and G₅ independently of one another are hydrogen, C₁-C₁₈alkyl, phenyl or phenyl substituted by 1, 2 or 3 C₁-C₄alkyl;
n is 1 or 2,
when n is 1, G₁ is C₁-C₁₈alkyl, or C₂-C₁₈hydroxyalkyl which is interrupted by oxygen, and when n is 2, G₁ is a bridging group of formula ROCOR′, wherein R and R′ independently of one another are C₁-C₁₈alkylidene, 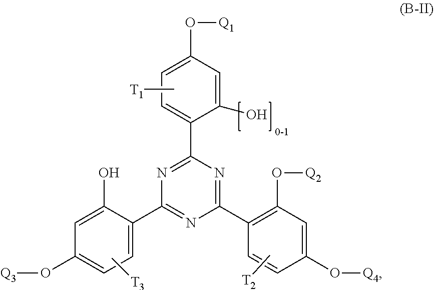
wherein Q₁, Q₂, Q₃ and Q₄ are independently of one another hydrogen, C₁-C₁₈alkyl, C₁-C₁₈alkyl substituted by hydroxy, C₂-C₁₈alkyl or C₂-C₁₈hydroxyalkyl interrupted by oxygen, C₁-C₁₈alkyl substituted by 1, 2 or 3 radicals selected from the group consisting of —OH, C₂-C₁₈alkenyloxy, —C(O)OX₁ and —OC(O)X₂ with X₁ and X₂ being independently C₁-C₁₈alkyl, and T₁, T₂ and T₃ are independently from each other hydrogen or C₁-C₁₈alkyl.

7. The method according to claim 1, wherein in the hydroxyphenyl triazine of the formulae (B-I) and (B-II),
G₂, G₃, G₄ and G₅ are independently from each other hydrogen, C₁-C₄alkyl or phenyl,
Q₁, Q₂, Q₃ and Q₄ are independently from each other hydrogen or C₁-C₁₀alkyl, and
T₁, T₂ and T₃ are independently from each other hydrogen or C₁-C₄alkyl.

8. The method according to claim 1, wherein the hydroxyphenyl triazine is at least one compound selected from the formulae (B1) to (B6)

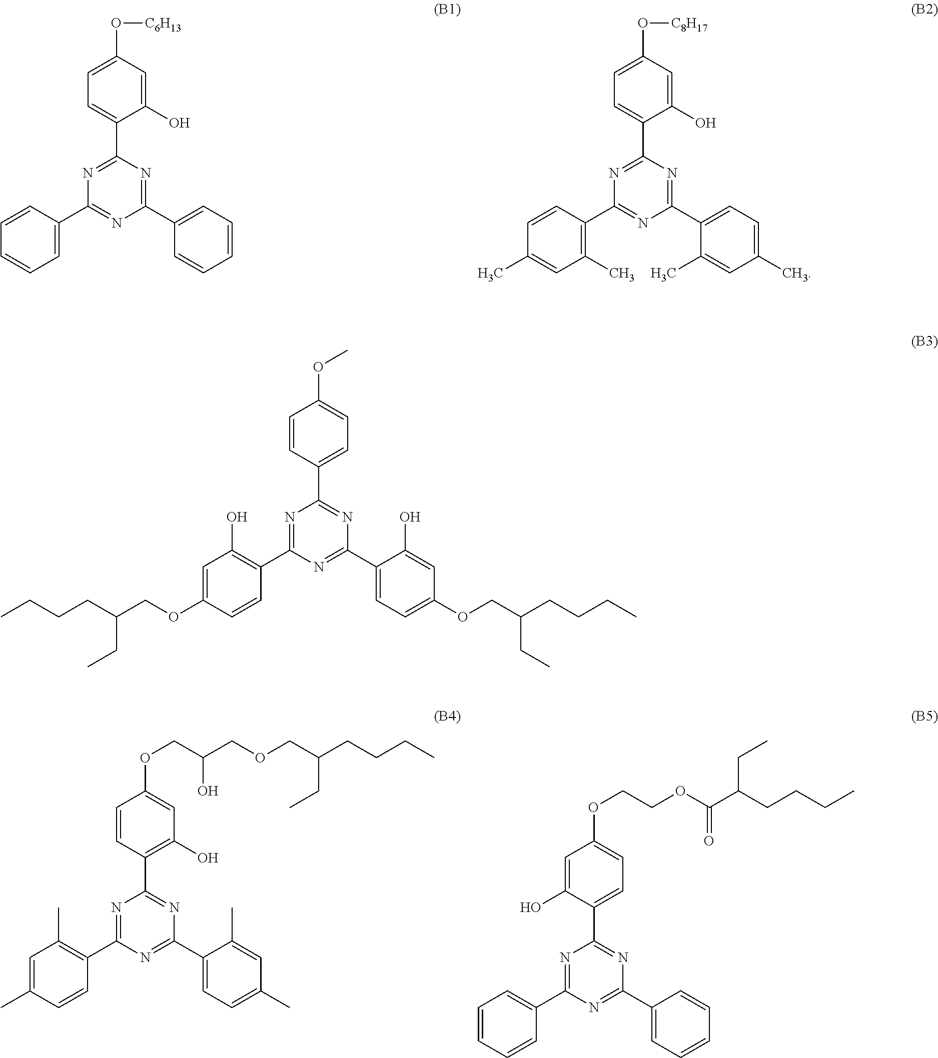

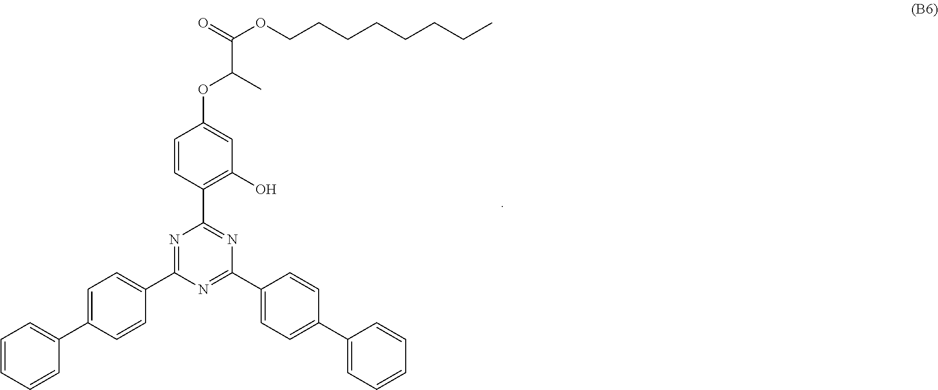 [SMILES: CCCCCCCCOC(=O)C(C)Oc1ccc(-c2nc(-c3ccc(-c4ccccc4)cc3)nc(-c3ccc(-c4ccccc4)cc3)n2)c(O)c1]

9. The method according to claim 1, wherein the further increase of stability against degradation induced by light is determined when comparing a) the synthetic polymer stabilized with the hydroxyphenyl triazine, but without the co-stabilizer, and b) the synthetic polymer stabilized with the hydroxyphenyl triazine and the co-stabilizer.

10. The method according to claim 1, wherein the co-stabilizer is present in the synthetic polymer in an amount of 0.0005 to 10%, relative to the weight of the synthetic polymer.

11. The method according to claim 1, wherein the hydroxyphenyl triazine is present in the synthetic polymer in an amount of 0.005 to 10%, relative to the weight of the synthetic polymer.

12. The method of claim 2, wherein the weight ratio of the co-stabilizer to the hydroxyphenyl triazine is from 1:25 to 1:50.

13. The method of claim 3, wherein E1 is linear or branched octyl.

14. The method of claim 1, wherein the co-stabilizer and the hydroxyphenyl triazine are added to the synthetic polymer individually.

15. The method of claim 1, wherein the co-stabilizer and the hydroxyphenyl triazine are mixed together and added as a mix to the synthetic polymer.

16. The method according to claim 1, wherein the co-stabilizer is present in the synthetic polymer in an amount of 0.05 to 2%, relative to the weight of the synthetic polymer.

17. The method according to claim 1, wherein the hydroxyphenyl triazine is present in the synthetic polymer in an amount of 0.05 to 2%, relative to the weight of the synthetic polymer.
